(19) United States
(12) Patent Application Publication
(10) Pub. No.: US 2016/0181601 A1
(43) Pub. Date: Jun. 23, 2016

(54) COMPOSITE PARTICLES, METHOD FOR MANUFACTURING SAME, ELECTRODE, AND NON-AQUEOUS ELECTROLYTE SECONDARY CELL

(71) Applicant: NIPPON STEEL & SUMITOMO METAL CORPORATION, Tokyo (JP)

(72) Inventors: Masafumi USUI, Tokyo (JP); Noriyuki NEGI, Tokyo (JP); Tooru FUJIWARA, Tokyo (JP)

(21) Appl. No.: 14/906,587

(22) PCT Filed: Jul. 4, 2014
(86) PCT No.: PCT/JP2014/067918

§ 371 Date: Jan. 21, 2016

(30) Foreign Application Priority Data
Jul. 23, 2013 (JP) 2013-152409

(51) Int. Cl. H01M 4/38; H01M 4/62; H01M 10/0525

(52) U.S. Cl. CPC H01M 4/386; H01M 10/0525; H01M 4/621

(57) ABSTRACT

An object of the present invention is to provide a negative electrode active material that can bring about improved charge/discharge cycle characteristics of nonaqueous electrolyte secondary cells that use silicon-containing particles as the negative electrode active material, and to provide a method for manufacturing the negative electrode active material. The method for manufacturing composite particles according to the present invention includes a mixing step and an annealing step. In the mixing step, a mixed powder is produced by mixing silicon phase-containing particles with a thermoplastic organic material powder. The mixed powder is annealed in the annealing step. The composite particles according to the present invention are obtained by this method for manufacturing composite particles.

### TECHNICAL FIELD

The present invention relates to composite particles and to a method for manufacturing same. The present invention further relates to an electrode obtained from these composite particles and to a nonaqueous electrolyte secondary cell.

### BACKGROUND ART

The “coating of silicon-containing particles with a carbon material using, for example, a CVD method” has already been proposed in order to improve the charge/discharge cycle characteristics of nonaqueous electrolyte secondary cells that use silicon-containing particles as negative electrode active materials (refer, for example, to Japanese Patent Application Laid-open No. 2005-235589, Japanese Patent Application Laid-open No. 2004-047404, and Japanese Patent Application Laid-open No. H10-321226).

### PRIOR ART DOCUMENTS

### Patent Literature

[PTL 1] Japanese Patent Application Laid-open No. 2005-235589

[PTL 2] Japanese Patent Application Laid-open No. 2004-047404

[PTL 3] Japanese Patent Application Laid-open No. H10-321226

### SUMMARY OF INVENTION

### Technical Problem

However, there has been demand in recent years for additional improvements in the charge/discharge cycle characteristics of such nonaqueous electrolyte secondary cells.

An object of the present invention is to provide a negative electrode active material that can bring about improved charge/discharge cycle characteristics of nonaqueous electrolyte secondary cells that use silicon-containing particles as the negative electrode active material. A further object is to provide a method for manufacturing the negative electrode active material.

### Solution to Problem

The method for manufacturing composite particles according to the present invention is provided with a mixing step and an annealing step. In the mixing step, a mixed powder is produced by mixing particles containing a silicon phase (referred to herebelow as “silicon phase-containing particles”) with a thermoplastic organic material powder. The “silicon phase-containing particles” referenced here may be “silicon particles formed from only a silicon phase” or may be “alloy particles in which a silicon phase is dispersed in a lithium-inert phase (for example, a metal silicide phase)”. The “thermoplastic organic material powder” referenced here is, for example, a petroleum-based pitch powder, a coal-based pitch powder, a thermoplastic resin powder, and so forth. The mixing method is preferably dry mixing. The mixed powder is subjected to an annealing in the annealing step. The composite particles according to the present invention are obtained from this annealing step.

The method for manufacturing composite particles according to the present invention can produce, while using a relatively small amount of the thermoplastic organic material powder, a negative electrode active material (composite particles) that can provide improvements in the charge/discharge cycle characteristics of nonaqueous electrolyte secondary cells. Due to this, this method for manufacturing composite particles can produce such a negative electrode active material while reducing raw material costs from previous raw material costs.

In the method for manufacturing composite particles according to the present invention, the mixed powder is preferably produced in the mixing step by mixing the silicon phase-containing particles and the thermoplastic organic material powder such that the percentage of the mass of the silicon phase-containing particles with respect to the sum of the mass of the silicon phase-containing particles and the mass of the thermoplastic organic material powder is in the range from 85% to 99%. By doing this, the charge/discharge cycle characteristics of the nonaqueous electrolyte secondary cell can be improved without significantly reducing the charge/discharge capacity. The mixed powder is more preferably produced in this mixing step by mixing the silicon phase-containing particles and the thermoplastic organic material powder such that the percentage of the mass of the silicon phase-containing particles with respect to the sum of the mass of the silicon phase-containing particles and the mass of the thermoplastic organic material powder is in the range from 90% to 99%. This percentage is even more preferably brought into the range from 92% to 98%.

The mixed powder is preferably annealed at a temperature within the range from 300° C. to 900° C. in the annealing step in the method for manufacturing composite particles according to the present invention. By doing this, the charge/discharge cycle characteristics of the nonaqueous electrolyte secondary cell can be improved even further while lowering the energy used during production of the negative electrode active material. The mixed powder is more preferably annealed in this annealing step at a temperature within the range from 300° C. to 700° C.

The composite particle according to the present invention is provided with a particle portion that contains a silicon phase (referred to herebelow as a “silicon phase-containing particle portion”) and with a binder portion. The “silicon phase-containing particle portion” referenced here may be a “silicon particle portion formed from only a silicon phase” or may be an “alloy particle portion in which a silicon phase is dispersed in a lithium-inert phase (for example, a metal silicide phase)”. The binder portion has at least one of a nongraphitic carbon and a carbon precursor as its main component. Preferably the binder portion has at least the carbon precursor of the nongraphitic carbon and the carbon precursor as its main component. In addition, this binder portion binds the silicon phase-containing particle portion. The composite particle according to the present invention is useful as an electrode active material, and particularly as a negative electrode active material, for nonaqueous electrolyte secondary cells (for example, lithium ion secondary cells).

In the composite particle according to the present invention, the percentage of the mass of the silicon phase-containing particle portion with respect to the sum of the mass of the silicon phase-containing particle portion and the mass of the binder portion is preferably in the range from 92% to 99.5%. This percentage is more preferably in the range from 95% to 99.5%. This percentage is even more preferably in the range from 95% to 99%.

Preferably at least a portion of the silicon phase-containing particle portion is exposed to the outside in the composite particle according to the present invention.

The maximum grain size of the silicon phase is preferably equal to or less than 1000 nm in the composite particle according to the present invention. The maximum grain size of the silicon phase in this composite particle is more preferably equal to or less than 500 nm.

The specific surface area value of the composite particle according to the present invention is preferably in the range from 0.5 m²/g to 16 m²/g. The specific surface area value of this composite particle is more preferably in the range from 1 m²/g to 11 m²/g.

### BRIEF DESCRIPTION OF DRAWINGS

FIG. 1 is a schematic cross-sectional view of a composite particle according to an embodiment of the present invention.

FIG. 2 is an image of the composite particle according to Working Example 1 of the present invention, obtained with a high-angle scattering annular dark-field scanning transmission microscope (the white regions indicate silicon and the black regions indicate carbon), and an elemental analysis chart at each of the six points +1 to +6.

FIG. 3 is an image of the composite particle according to Working Example 1 of the present invention, obtained with a high-angle scattering annular dark-field scanning transmission microscope (the white regions indicate silicon and the black regions indicate carbon), and shows the presence of the binder portion and the exposure of the silicon phase-containing particle portion.

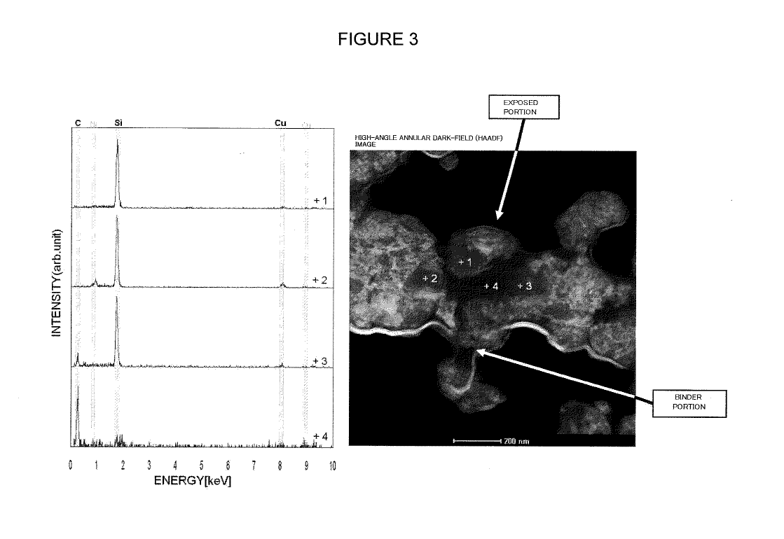

### EXPLANATION OF SYMBOL

100 composite particle
110 silicon phase-containing particle portion
120 binder portion

### DESCRIPTION OF EMBODIMENTS

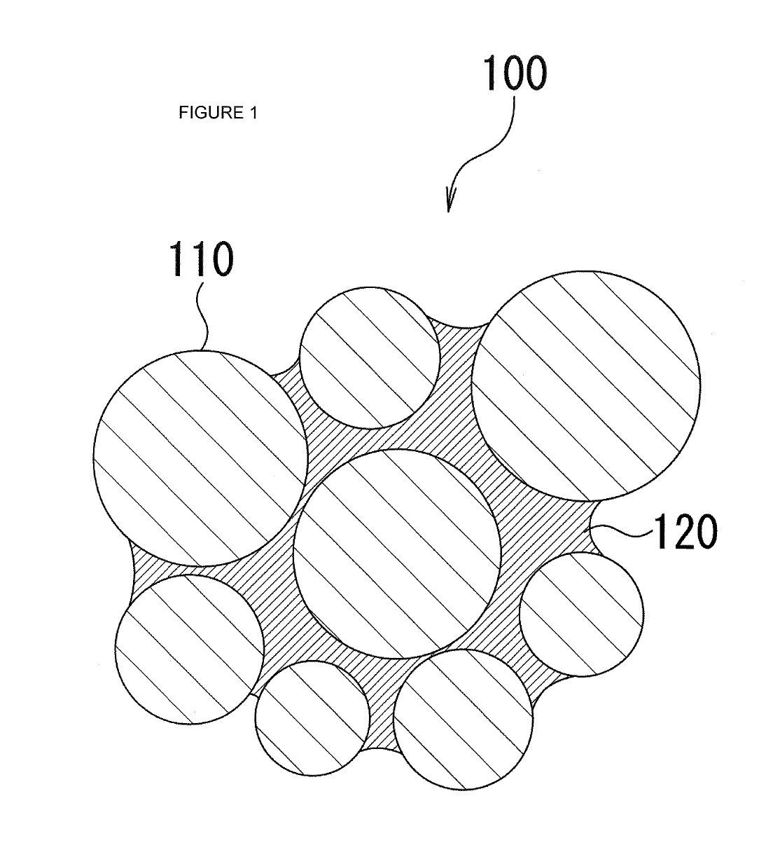

The composite particle according to embodiments of the present invention is formed by the binding together of a plurality of silicon phase-containing particles through a binding portion. That is, as shown in FIG. 1, this composite particle 100 is constituted mainly of a silicon phase-containing particle portion 110 and a binder portion 120. The specific surface area value of this composite particle 100 is preferably in the range from 0.5 m²/g to 16 m²/g and more preferably is in the range from 1 m²/g to 11 m²/g. The silicon phase-containing particle portion 110 and the binder portion 120 are each described in detail below, and the method for manufacturing the composite particle 100 is also described in detail below.

<Details for the Composite Particle>

(1) The Silicon Phase-Containing Particle Portion

The silicon phase-containing particle portion may be “silicon particles” constituted of only a silicon phase or may be an “alloy particle portion in which a silicon phase is dispersed in a lithium-inert phase”. The percentage in this composite particle for the mass of the silicon phase-containing particle portion with respect to the sum of the mass of the silicon phase-containing particle portion and the mass of the binder portion is preferably in the range from 92% to 99.5%, more preferably in the range from 95% to 99.5%, even more preferably in the range from 95% to 99%, and particularly preferably in the range from 96% to 98.5%. Preferably at least a portion of the silicon phase-containing particle portion is exposed to the outside.

(1-1) The Silicon Phase

The silicon phase is formed principally of silicon atoms. The silicon phase is preferably formed from only silicon atoms. More strain (dislocations) is introduced into this silicon phase as it is further from a perfectly crystalline material.

The maximum grain size of the silicon phase is preferably in the range from greater than 0 nm to not more than 1000 nm, more preferably in the range from greater than 0 nm to not more than 700 nm, even more preferably in the range from greater than 0 nm to not more than 500 nm, particularly preferably in the range from greater than 0 nm to not more than 300 nm, and most preferably in the range from greater than 0 nm to not more than 200 nm. The maximum grain size of the silicon phase here indicates the maximum value among the longest diameters of the silicon-phase crystal grains in the field of view in observation with a transmission electron microscope (TEM).

(1-2) The Lithium-Inert Phase

The lithium-inert phase is a phase that substantially does not incorporate the lithium ion. A metal silicide phase is preferred for the lithium-inert phase. The metal silicide phase is formed from the silicon atom and at least one species of metal atom. The metal silicide phase may be an intermetallic compound. More strain (dislocations) is introduced into this metal silicide phase as it is further from a perfectly crystalline material.

This metal silicide phase preferably principally has the composition MSix. Here, M is at least one species of metal element; Si is silicon; and x has a value greater than 0 and less than 2. This M is preferably at least one metal element selected from the group consisting of aluminum (Al), iron (Fe), nickel (Ni), titanium (Ti), copper (Cu), cobalt (Co), chromium (Cr), vanadium (V), manganese (Mn), zinc (Zn), yttrium (Y), zirconium (Zr), niobium (Nb), molybdenum (Mo), ruthenium (Ru), rhodium (Rh), palladium (Pd), silver (Ag), indium (In), hafnium (Hf), tantalum (Ta), tungsten (W), platinum (Pt), lanthanum (La), cerium (Ce), praseodymium (Pr), and neodymium (Nd).

A system other than MSix, e.g., TiSi₂, Ni₄Ti₄Si₇, NiSi₂, and so forth, may be present in the metal silicide phase within a range in which the effects of the present invention are not impaired. In such cases, the content of the MSix in the metal silicide phase is preferably at least 20 volume % and is more preferably at least 30 volume %.

The lithium-inert phase may also be, for example, a compound that contains the element Al or Sn, e.g., Al₂Cu, NiAl₃, Ni₂Al₃, Al₃Ce, Mn₃Sn, Ti₆Sn₅, and so forth, or an intermetallic compound provided by combining transition elements, e.g., TiCo₂, Cu₄Ti, Fe₂Ti, Co₂NiV, and so forth.

(1-3) Method of Producing Alloy Particles

When the silicon phase-containing particle portion is an alloy particle portion, these alloy particles can be produced by going through a metal melting step, a quenching and solidification step, a pulverization step, and a mechanical grinding step. Each of these steps is described in detail in the following.

(a) the Metal Melting Step

A prescribed molten metal bath is produced in the metal melting step by melting a plurality of starting metal materials that contain silicon (Si). In this case, the silicon (Si) is added to the starting metal materials so that a silicon phase precipitates. The amount of addition for the silicon (Si) can be easily determined using an equilibrium diagram. The starting metal materials need not undergo simultaneous melting and may melt in stages.

The starting metal materials are usually brought into a molten state through the application of heat. The starting metal materials are preferably heated and melted under an inert gas atmosphere or under a vacuum atmosphere.

The heating method can be exemplified by high-frequency induction heating, arc discharge heating (arc melting), plasma discharge heating (plasma melting), and resistance heating. It is critical that a compositionally homogeneous molten bath be formed in this step.

(b) the Quenching and Solidification Step

A prescribed alloy solid is produced in the quenching and solidification step by quenching and solidifying the prescribed alloy molten bath. The prescribed alloy molten bath is preferably quenched and solidified in this quenching and solidification step at a cooling rate of at least 100 K/second, while the prescribed alloy molten bath is more preferably quenched and solidified at a cooling rate of at least 1,000 K/second.

The quenching and solidification method (quenching and casting method) can be exemplified by the gas atomization method, roll quenching method, flat plate casting method, rotating electrode method, liquid atomization method, and melt spinning method.

The gas atomization method is a method in which a molten metal bath residing in a tundish flows out from a small hole at the bottom of the tundish and an inert gas, such as argon (Ar), nitrogen (N₂), or helium (He), is blown at high pressure into the resulting fine stream of the molten metal bath, causing particulation of the molten metal bath while bringing about solidification in a powder form and yielding spherical particles.

The roll quenching method is a method in which the molten metal bath is run down onto a rapidly rotating single roll or pair of rolls, or the molten metal bath is drawn up by a roll, to thereby yield a thin slab. The obtained thin slab is pulverized to a suitable size in the ensuing pulverization step.

The flat plate casting method is a method in which the molten metal bath is cast into a flat plate-shaped mold that gives a thin ingot, which provides a faster cooling rate than a block-shaped ingot. The obtained flat plate-shaped ingot is pulverized to a suitable size in the ensuing pulverization step.

(c) the Pulverization Step

A prescribed alloy powder is formed in the pulverization step by the pulverization of the prescribed alloy solid. This pulverization step is preferably carried out in a nonoxidizing atmosphere. This is done for the following reason: when the prescribed alloy solid is pulverized in the pulverization step, the specific surface area is increased at the same time that a new surface is formed. The nonoxidizing atmosphere is preferably an inert gas atmosphere, but the presence of from about 2 to 5 volume oxygen does not pose a particular problem.

(d) the Mechanical Grinding Step

The aforementioned alloy particles are produced in the mechanical grinding step by subjecting the prescribed alloy powder to a mechanical grinding process (abbreviated below as the “MG process”). The prescribed alloy powder fed to the MG process preferably has an average particle diameter of not more than 5 mm, more preferably has an average particle diameter of not more than 1 mm, even more preferably has an average particle diameter of not more than 500 and even more preferably has an average particle diameter of not more than 100 μm.

In the MG process, compressive force and shear force are applied to the powder, which is the material being processed, and the powder is repetitively disintegrated and granulated while the powder is being ground. As a result, the original structure of the powder is collapsed and a particle is formed that has a structure in which the phases present prior to the processing are ultramicrofinely dispersed at the nanometer level. However, the type and content of the phases constituting this microstructure are substantially the same as prior to the processing, and the formation of new phases due to the processing does not occur. When the alloy particle according to the present invention is used as a negative electrode material for a nonaqueous electrolyte secondary cell, due to the characteristics of this MG process, the negative electrode will then exhibit a stable discharge capacity. This differs from the MA method (mechanical alloying method), in which an alloying reaction occurs between the elements and the phase contents are then changed by the process. It is unproblematic for a local mechanical alloying to be produced in a small part of the alloy powder during the MG process sequence.

In a general pulverization, on the other hand, the structure (more specifically the crystalline structure) is not collapsed. Consequently, the pre-pulverization structure is retained by the post-pulverization particles. That is, just the particle diameter is reduced in a pulverization while a microfine-sizing of the structure does not occur. The MG process, in which during processing the structure is ground and collapsed and the structure is microfine-sized, differs from pulverization in this regard.

The MG process can be carried out by any milling device capable of grinding up a material. Among such milling devices, milling devices that use a ball-shaped grinding medium, i.e., ball mill-type milling devices, are preferred. Ball mill-type milling devices offer the advantages of, for example, a simple construction, ease of acquisition of the grinding media balls in a wide variety of materials, and the execution of uniform grinding at a large number of locations due to the occurrence of comminution grinding at the contact points between the balls (this is particularly important from the standpoint of a highly uniform reaction, i.e., product stability), and thus are particularly favorable for use in the present invention. In addition, the following, inter alia, are preferred among ball mill-type milling devices because they engage in not just a simple rotation of the milling vessel: vibrating ball mills, in which the grinding energy is raised through the application of vibration; attritors, in which the material being processed and the grinding media balls are forcibly stirred by a rotating rod; and planetary ball mills, in which the grinding energy is raised due to rotational force and centrifugal force.

In order to prevent oxidation of the material during processing, the MG process is preferably carried out in an inert gas atmosphere, for example, of argon. However, as in the quenching and solidification step, a material may be subjected to MG processing in an air atmosphere if the material does not contain easily oxidizable metal elements. In the present embodiment, the metal particles after MG processing preferably have an oxygen concentration of not more than 7.0 mass % and more preferably not more than 5.0 mass %. The reason for this is as follows: when the oxygen concentration in the metal particles after MG processing is not more than 7.0 mass %, and when such metal particles are used as an electrode material in a nonaqueous electrolyte secondary cell, the irreversible capacity will then be relatively small and the charge/discharge efficiency can be well maintained.

When the alloying temperature is raised by the heat generated by processing during the MG process, the risk then arises that the size of the texture within the ultimately obtained alloy particle will undergo coarsening. Due to this, the milling device is preferably provided with a cooling mechanism. In this case, the MG process can be carried out while the system interior is cooled.

(2) The Binder Portion

The binder portion has at least one of a nongraphitic carbon and a carbon precursor as its main component and binds the silicon phase-containing particle portion. Preferably the binder portion has at least the carbon precursor of nongraphitic carbon and carbon precursor as its main component. The use of a carbon precursor as the main component makes it possible to stably inhibit degradation of the solvent in the electrolyte solution.

The nongraphitic carbon is at least either of amorphous carbon and turbostratic carbon. Here, “amorphous carbon” refers to carbon that, while having short-range order (on the order of several atoms to more than a dozen of atoms), does not have long-range order (on the order of several hundred to several thousand atoms). In addition, the “turbostratic carbon” here refers to carbon composed of carbon atoms that have a turbostratic structure that is parallel in the direction of the plane of the hexagonal network, but for which no crystallographic regularity is seen in the three-dimensional direction. This turbostratically structured carbon is preferably confirmed using, for example, a transmission electron microscope (TEM).

This nongraphitic carbon is obtained by baking a thermoplastic organic material such as a thermoplastic resin. In embodiments of the present invention, the thermoplastic resin is, for example, a petroleum-based pitch, coal-based pitch, synthetic thermoplastic resin, natural thermoplastic resin, or mixture of the preceding. A pitch powder is particularly preferred from among the preceding. The reason for this is as follows: a pitch powder undergoes carbonization along with melting during the temperature ramp-up process, and as a result can bring about a favorable binding among the silicon phase-containing particles 110. Pitch powder is preferred from the standpoint of obtaining a small irreversible capacity even with a low-temperature baking.

The carbon precursor is the carbon-rich material prior to the conversion of a thermoplastic organic material into a nongraphitic carbon when a thermoplastic organic material is annealed.

The binder portion may contain other components, e.g., graphite, finely divided electroconductive carbonaceous particles, tin particles, and so forth, within a range in which the effects of the present invention are not impaired.

The graphite may be either natural graphite or synthetic graphite, but is preferably natural graphite. A mixture of natural graphite and synthetic graphite may be used for the graphite. In addition, the graphite may be a spherical graphite granulate formed by aggregating a plurality of graphite flakes. The flake graphite can be a natural graphite or a synthetic graphite or can be provided by the graphitization of, for example, a mesophase baked carbon (bulk mesophase) for which tar•pitch is the starting material, or by the graphitization of a coke (raw coke, green coke, pitch coke, needle coke, petroleum coke, and so forth). Graphite provided by granulation using a plurality of highly crystalline natural graphites is preferred in particular.

The finely divided electroconductive carbonaceous particles are directly attached to the graphite. The finely divided electroconductive carbonaceous particles can be exemplified by carbon blacks such as Ketjenblack, furnace black, and acetylene black, and by carbon nanotubes, carbon nanofibers, and carbon nanocoils. Acetylene black is preferred in particular among these finely divided electroconductive carbonaceous particles. In addition, the finely divided electroconductive carbonaceous particles may be a mixture of, for example, different carbon blacks.

<The Method for Manufacturing the Composite Particles>

The composite particles according to embodiments of the present invention are manufactured through a mixing step and an annealing step.

In the mixing step, a mixed powder is produced by the solid-phase mixing of the silicon phase-containing particles (powder) and a powder of the thermoplastic organic material. Prior to the mixing step, the silicon phase-containing particles (powder) may be subjected to a classification process in order to reduce the fines percentage. Doing this has the effects of providing a smaller specific surface area, suppressing the degradation reactions of the electrolyte solution that arise during the initial charging, and improving the initial efficiency as a negative electrode material.

In the annealing step, the mixed powder is annealed in a nonoxidizing atmosphere (for example, in an inert gas atmosphere or a vacuum atmosphere) at a temperature in the range from 300° C. to 1200° C., preferably at a temperature in the range from 300° C. to 1000° C., more preferably at a temperature in the range from 300° C. to 900° C., even more preferably at a temperature in the range from 300° C. to 800° C., particularly preferably at a temperature in the range from 300° C. to 700° C., and most preferably at a temperature in the range from 400° C. to 700° C. As a result, the thermoplastic organic material powder undergoes softening and binds the silicon phase-containing particles (powder) to each other; the thermoplastic organic material powder is also converted into at least one of nongraphitic carbon and carbon precursor; and the target composite particle is thereby obtained. The growth of the particle size of the silicon phase can be inhibited by having the annealing temperature be not more than 900° C., and the charge/discharge cycle characteristics can be improved as a result. Having the annealing temperature be at least 300° C. makes it possible to obtain a stable binding of the silicon phase-containing particles with each other through the thermoplastic organic material. Thus, an electrode having excellent charge/discharge cycle characteristics can be formed when the annealing temperature is in the indicated range.

<Characteristics of the Composite Particle According to Embodiments of the Present Invention>

The composite particle according to embodiments of the present invention can bring about additional improvements in the charge/discharge cycle characteristics when used as an electrode active material in nonaqueous electrolyte secondary cells.

<Electrode Fabrication>

The electrode according to embodiments of the present invention can be formed from the composite particles that have been described in the preceding. For example, an electrode mixture is produced by mixing a suitable binder with the composite particles and as necessary mixing a suitable electroconductive powder in order to improve the conductivity. The electrode mixture is then converted into a slurry by the addition to the electrode mixture of a solvent that can dissolve the binder and as necessary thoroughly stirring using a homogenizer and glass beads. A slurry kneader/mixer that combines rotational motion with orbital motion may be used here. An electrode for application in a nonaqueous electrolyte secondary cell is obtained when this electrode mixture slurry is coated, using, for example, a doctor blade, on an electrode substrate (current collector), e.g., rolled copper foil or electrolytic copper foil, followed by drying and then consolidation by, for example, rolling with a roll. This electrode is commonly used as a negative electrode.

The binder can be exemplified by non-water-soluble resins (which, however, are insoluble in the solvent used in the nonaqueous electrolyte for the cell), e.g., polyvinylidene fluoride (PVDF), polymethyl methacrylate (PMMA), and polytetrafluoroethylene (PTFE); water-soluble resins such as carboxymethyl cellulose (CMC) and polyvinyl alcohol (PVA); and aqueous dispersion-type binders such as styrene-butadiene rubber (SBR). The solvent for the binder can be water or an organic solvent such as N-methylpyrrolidone (NMP) or dimethylformamide (DMF) in correspondence to the binder.

The electroconductive powder can be exemplified by carbon materials (for example, carbon black, graphite) and metals (for example, Ni), while carbon materials are preferred therebetween. Carbon materials can incorporate and store the Li ion in their interlayers and because of this can also contribute to the capacity of the negative electrode in addition to contributing electroconductivity; they also have a high liquid retention behavior. Acetylene black is particularly preferred among these carbon materials.

<Fabrication of the Nonaqueous Electrolyte Secondary Cell>

The nonaqueous electrolyte secondary cell according to embodiments of the present invention is fabricated using the hereabove-described negative electrode. The nonaqueous electrolyte secondary cell is, for example, a lithium ion secondary cell. The hereabove-described composite particle and electrode are advantageous as the negative electrode active material and negative electrode of lithium ion secondary cells. However, the composite particle and electrode according to the present embodiment can in theory also be applied to other nonaqueous electrolyte secondary cells.

In its basic structure a nonaqueous electrolyte secondary cell is provided with a negative electrode, positive electrode, separator, and nonaqueous electrolyte. A negative electrode manufactured according to the present invention as described hereabove is used as the negative electrode, but known materials, or those developed hereafter, may be used as appropriate for the positive electrode, separator, and electrolyte.

The nonaqueous electrolyte may be a liquid or a solid or a gel. The solid electrolytes can be exemplified by polymer electrolytes such as polyethylene oxide, polytetrafluoroethylene, fluorine-containing copolymers, and combinations of the preceding. The liquid electrolytes can be exemplified by ethylene carbonate, diethyl carbonate, propylene carbonate, and combinations of the preceding. The electrolyte is provided with a lithium electrolyte salt. Suitable salts can be exemplified by lithium hexafluorophosphate (LiPF₆), lithium tetrafluoroborate (LiBF₄), and lithium perchlorate (LiClO₄). Suitable cathode compositions can be exemplified by lithium cobaltate (LiCoO₂), lithium manganate (LiMn₂O₄), and LiCo_{0.2}Ni_{0.8}O₂.

### Working Examples and Comparative Examples

The present invention is described in detail herebelow using working examples and comparative examples. The present invention is not limited to or by these working examples.

### Working Example 1

### Manufacture of the Composite Particles

(1) Alloy Particle Production

First, pure starting materials of copper (Cu), nickel (Ni), titanium (Ti), and silicon (Si) were introduced into an aluminum titanate melting crucible at a copper:nickel:titanium:silicon mass ratio of 8.4:16.5:13.0:62.1. The interior of the melting crucible was then made an argon (Ar) atmosphere and the pure starting materials (metal mixture) within the melting crucible were completely melted by heating to 1500° C. by high-frequency induction heating. The melt was subsequently quenched and solidified by bringing it into contact onto a water-cooled copper roll that was rotating at a peripheral velocity of 90 m/minute, thereby obtaining a thin slab (strip casting (SC) method). The cooling rate at this time was assumed to be about 500 to 2,000° C./second. The thusly obtained slab was pulverized followed by classification on a 63 μm screen to produce a primary powder having an average particle diameter of 25 to 30 μm. This primary powder was introduced along with stearic acid (in an amount that was 1 mass % with respect to the primary powder) into a high-speed ball mill (capacity=5 liters), and the primary powder was subjected to a mechanical grinding process (abbreviated below as the “MG process”) for 15 hours at a rotation rate of 300 rpm to produce an alloy powder (a single grain of the alloy powder is in some instances referred to as an “alloy particle” in the following). 450 g of approximately 8 mmφ SUJ2 balls per 10 g of the primary powder was introduced here.

(2) Production of the Mixed Powder

This alloy powder and a coal-based pitch powder (softening point=86° C., average particle diameter=20 μm, residual carbon after heating at 1000° C.=50%) were introduced—so as to provide a percentage of 96.0% for the mass of the alloy powder with respect to the sum of the mass of the alloy powder and the mass of the coal-based pitch powder—into a rocking mixer (Aichi Electric Co., Ltd.) and a mixed powder was produced.

(3) Annealing of the Mixed Powder

The mixed powder was then introduced into a graphite crucible and, while in a nitrogen current, this mixed powder was annealed for 1 hour at a temperature of 200° C. and then additionally for 1 hour at a temperature of 400° C. to obtain the target composite particles. The percentage in these composite particles for the mass of the alloy powder with respect to the sum of the mass of the alloy powder and the mass of the coal-based pitch powder-derived material (thought to be mainly carbon precursor) was 98.0% (refer to Table 1).

<Evaluation of the Properties of the Composite Particles>

(1) Measurement of the Crystal Size of the Silicon Phase

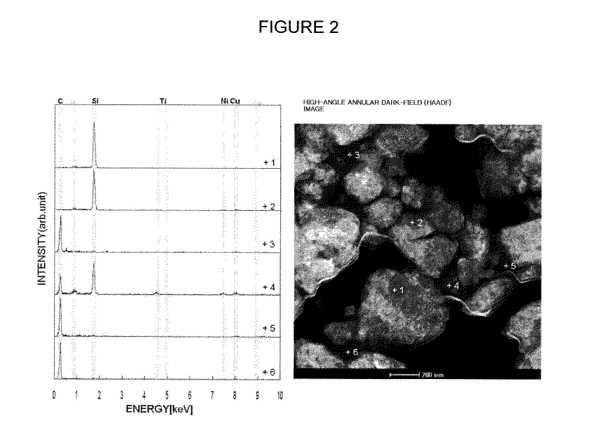

Using a transmission electron micrograph (bright-field image) (refer to FIG. 2), the grain size of the silicon phase was directly measured at the nm level (less than 1 micrometer). In addition, using a scanning electron micrograph of the cross section of a sample obtained by sectioning the composite particle so as to expose the alloy particle cross section, the longest diameter of the silicon phase was directly measured at the μm level (at least 1 μm). The maximum grain size (longest diameter) of the silicon phase in the alloy particle according to this working example was 190 nm (refer to Table 1).

(2) Measurement of the Specific Surface Area of the Composite Particles

The specific surface area of the composite particles was determined by the one-point BET procedure using a Quantasorb from Yuasa Ionics Co., Ltd. The result was a BET specific surface area for these composite particles of 2.5 m²/g (refer to Table 1).

(3) Evaluation of the Cell Properties

(3-1) Electrode Fabrication

Sodium carboxymethyl cellulose (CMC) powder and acetylene black (Denka Black from Denki Kagaku Kogyo Kabushiki Kaisha, powder product) were mixed into the composite particles; an aqueous dispersion of styrene-butadiene rubber (SBR) was added to the resulting mixed powder; and the mixture was then stirred to obtain an electrode mixture slurry. The CMC and SBR are binders here. The blending ratio for the composite particles, CMC, acetylene black, and SBR was 75.0:5.0:15.0:5.0 as the mass ratio. This electrode mixture slurry was applied (the application rate was 2.5 to 3.5 mg/cm²) by a doctor blade procedure on a 17 μm-thick copper foil (current collector). The applied liquid was dried to obtain a coating film, and this coating film was punched out into a disk with a diameter of 13 mm.

(3-2) Cell Fabrication

An electrode assembly was fabricated by placing this electrode and an Li metal foil counterelectrode on the two sides of a polyolefin separator. A 2016 cell size coin-type nonaqueous test cell was fabricated by injecting an electrolyte solution into the interior of this electrode assembly. The composition of the electrolyte solution was LiPF₆:dimethyl carbonate (DMC):ethylene carbonate (EC):ethyl methyl carbonate (EMC):vinylene carbonate (VC):fluoroethylene carbonate (FEC)=16:48:23:4:1:8 (mass ratio).

(3-3) Evaluation of the Discharge Capacity, Charge/Discharge Efficiency, and Charge/Discharge Cycling

First, the doping capacity was measured by carrying out constant-current doping (insertion of lithium ions into the electrode, corresponds to the charging of a lithium ion secondary cell) on the coin-type nonaqueous test cell at a current value of 0.56 mA/cm² until the potential difference versus the counterelectrode reached 5 mV and then, while this 5 mV was maintained, continuing doping versus the counterelectrode at constant voltage until 7.5 μA/cm² was reached. The dedoping capacity was then measured by carrying out dedoping (release of lithium ions from the electrode, corresponds to the discharge of a lithium ion secondary cell) at a constant current of 0.56 mA/cm² until a potential difference of 1.2 V was reached. The doping capacity and dedoping capacity here corresponded to the charging capacity (mAh/g) and the discharge capacity (mAh/g) when this electrode is used as the negative electrode in a lithium ion secondary cell and for this reason were designated as the charging capacity and the discharge capacity. In addition, the initial charge/discharge efficiency (%) was taken to be “the discharge capacity during dedoping in the first cycle” divided by “the charging capacity during doping in the first cycle”, multiplied by 100.

Doping and dedoping were carried out repetitively 20 times under the same conditions as above. The capacity retention rate (%) was taken to be “the discharge capacity during dedoping in the twentieth cycle” divided by “the discharge capacity during dedoping in the first cycle”, multiplied by 100.

The coin-type nonaqueous test cell according to this working example had an initial charge/discharge efficiency of 87.9% and a capacity retention ratio of 60.3% (refer to Table

(3-4) Evaluation of the Electrolyte Degradability (Constant Potential Holding Test)

Constant potential electrolysis of the electrolyte solution was first carried out on the coin-type nonaqueous test cell by reducing the potential difference versus the counterelectrode through the stages of 2.00 V, 1.80 V, 1.60 V, 1.55 V, 1.50 V, 1.45 V, 1.4 V, 1.35 V, 1.30 V, 1.25 V, 1.20 V, 1.18 V, 1.15 V, 1.10 V, 1.05 V, and 1.00 V, and while this was being carried out the current flowing at each potential difference was measured and the amount of electricity for reactions was calculated at each potential difference from these current values. In this working example, the maximum amount of electricity for reactions (mAh/g), among the amounts of electricity for reactions at these multiple potential differences, was used as an index of the electrolyte solution degradability. The electrolyte solution degradability for this working example was 2.1 mAh/g.

### Working Example 2

The target composite particles were obtained proceeding as in Working Example 1, except that in the “(3) Annealing of the mixed powder” the additional annealing for 1 hour was carried out at a temperature of 500° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 98.0% (refer to Table 1).

The maximum grain size (longest diameter) of the silicon phase in the alloy particles obtained as described above was 261 nm, and the BET specific surface area was 4.5 m²/g (refer to Table 1). The coin-type nonaqueous test cell had an initial charge/discharge efficiency of 87.8% and a capacity retention ratio of 69.7% (refer to Table 1). The electrolyte solution degradability was 2.0 mAh/g (refer to Table 1).

### Working Example 3

The target composite particles were obtained proceeding as in Working Example 1, except that in the “(3) Annealing of the mixed powder” the additional annealing for 1 hour was carried out at a temperature of 600° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 98.0% (refer to Table 1).

The maximum grain size (longest diameter) of the silicon phase in the alloy particles obtained as described above was 368 nm, and the BET specific surface area was 9.7 m²/g (refer to Table 1). The coin-type nonaqueous test cell had an initial charge/discharge efficiency of 89.4% and a capacity retention ratio of 61.1% (refer to Table 1). The electrolyte solution degradability was 2.2 mAh/g (refer to Table 1).

### Working Example 4

The target composite particles were obtained proceeding as in Working Example 1, except that in the “(3) Annealing of the mixed powder” the additional annealing for 1 hour was carried out at a temperature of 700° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly nongraphitic carbon) was 98.0% (refer to Table 1).

The maximum grain size (longest diameter) of the silicon phase in the alloy particles obtained as described above was 500 nm, and the BET specific surface area was 10.9 m²/g (refer to Table 1). The coin-type nonaqueous test cell had an initial charge/discharge efficiency of 89.8% and a capacity retention ratio of 72.6% (refer to Table 1). The electrolyte solution degradability was 2.6 mAh/g (refer to Table 1).

### Working Example 5

The target composite particles were obtained proceeding as in Working Example 1, except that in the “(3) Annealing of the mixed powder” the additional annealing for 1 hour was carried out at a temperature of 300° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 96.6% (refer to Table 1).

The maximum grain size (longest diameter) of the silicon phase in the alloy particles obtained as described above was 143 nm, and the BET specific surface area was 1.2 m²/g (refer to Table 1). The coin-type nonaqueous test cell had an initial charge/discharge efficiency of 85.3% and a capacity retention ratio of 30.2% (refer to Table 1). The electrolyte solution degradability was 5.5 mAh/g (refer to Table 1).

### Working Example 6

The target composite particles were obtained proceeding as in Working Example 1, except that in the “(3) Annealing of the mixed powder” the additional annealing for 1 hour was carried out at a temperature of 350° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 96.6% (refer to Table 1).

The maximum grain size (longest diameter) of the silicon phase in the alloy particles obtained as described above was 155 nm, and the BET specific surface area was 1.7 m²/g (refer to Table 1). The coin-type nonaqueous test cell had an initial charge/discharge efficiency of 86.5% and a capacity retention ratio of 51.6% (refer to Table 1). The electrolyte solution degradability was 3.8 mAh/g (refer to Table 1).

### Working Example 7

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 μm, residual carbon ratio after heating at 1000° C.=50%) into the rocking mixer (Aichi Electric Co., Ltd.) so as to provide a percentage of 98.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 99.0% (refer to Table 1).

The maximum grain size (longest diameter) of the silicon phase in the alloy particles obtained as described above was 190 nm, and the BET specific surface area was 3.1 m²/g (refer to Table 1). The coin-type nonaqueous test cell had an initial charge/discharge efficiency of 87.9% and a capacity retention ratio of 49.7% (refer to Table 1). The electrolyte solution degradability was 1.8 mAh/g (refer to Table 1).

### Working Example 8

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 residual carbon ratio after heating at 1000° C.=50%) into the rocking mixer (Aichi Electric Co., Ltd.) so as to provide a percentage of 97.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 98.5% (refer to Table 1).

The maximum grain size (longest diameter) of the silicon phase in the alloy particles obtained as described above was 190 nm, and the BET specific surface area was 2.8 m²/g (refer to Table 1). The coin-type nonaqueous test cell had an initial charge/discharge efficiency of 87.9% and a capacity retention ratio of 60.0% (refer to Table 1). The electrolyte solution degradability was 2.1 mAh/g (refer to Table 1).

### Working Example 9

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 residual carbon ratio after heating at 1000° C.=50%) into the rocking mixer (Aichi Electric Co., Ltd.) so as to provide a percentage of 92.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 95.8% (refer to Table 1).

The maximum grain size (longest diameter) of the silicon phase in the alloy particles obtained as described above was 190 nm, and the BET specific surface area was 1.2 m²/g (refer to Table 1). The coin-type nonaqueous test cell had an initial charge/discharge efficiency of 86.6% and a capacity retention ratio of 81.0% (refer to Table 1). The electrolyte solution degradability was 3.2 mAh/g (refer to Table 1).

### Working Example 10

The target composite particles were obtained proceeding as in Working Example 1, except that in the “(3) Annealing of the mixed powder” the additional annealing for 1 hour was carried out at a temperature of 800° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly nongraphitic carbon) was 98.0% (refer to Table 1).

The maximum grain size (longest diameter) of the silicon phase in the alloy particles obtained as described above was 640 nm, and the BET specific surface area was 13.3 m²/g (refer to Table 1). The coin-type nonaqueous test cell had an initial charge/discharge efficiency of 89.8% and a capacity retention ratio of 75.1% (refer to Table 1). The electrolyte solution degradability was 2.7 mAh/g (refer to Table 1).

### Working Example 11

The target composite particles were obtained proceeding as in Working Example 1, except that in the “(3) Annealing of the mixed powder” the additional annealing for 1 hour was carried out at a temperature of 900° C. after the annealing for 1 hour at a temperature of 200° C. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly nongraphitic carbon) was 98.0% (refer to Table 1).

The maximum grain size (longest diameter) of the silicon phase in the alloy particles obtained as described above was 860 nm, and the BET specific surface area was 15.7 m²/g (refer to Table 1). The coin-type nonaqueous test cell had an initial charge/discharge efficiency of 90.3% and a capacity retention ratio of 77.7% (refer to Table 1). The electrolyte solution degradability was 2.8 mAh/g (refer to Table 1).

### Working Example 12

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 μm, residual carbon ratio after heating at 1000° C.=50%) into the rocking mixer (Aichi Electric Co., Ltd.) so as to provide a percentage of 95.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 97.5% (refer to Table 1).

The maximum grain size (longest diameter) of the silicon phase in the alloy particles obtained as described above was 190 nm, and the BET specific surface area was 2.2 m²/g (refer to Table 1). The coin-type nonaqueous test cell had an initial charge/discharge efficiency of 88.4% and a capacity retention ratio of 69.2% (refer to Table 1). The electrolyte solution degradability was 2.5 mAh/g (refer to Table 1).

### Working Example 13

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 μm, residual carbon ratio after heating at 1000° C.=50%) into the rocking mixer (Aichi Electric Co., Ltd.) so as to provide a percentage of 94.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 97.0% (refer to Table 1).

The maximum grain size (longest diameter) of the silicon phase in the alloy particles obtained as described above was 190 nm, and the BET specific surface area was 1.8 m²/g (refer to Table 1). The coin-type nonaqueous test cell had an initial charge/discharge efficiency of 88.2% and a capacity retention ratio of 73.2% (refer to Table 1). The electrolyte solution degradability was 2.7 mAh/g (refer to Table 1).

### Working Example 14

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 μm, residual carbon ratio after heating at 1000° C.=50%) into the rocking mixer (Aichi Electric Co., Ltd.) so as to provide a percentage of 93.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 96.5% (refer to Table 1).

The maximum grain size (longest diameter) of the silicon phase in the alloy particles obtained as described above was 190 nm, and the BET specific surface area was 1.5 m²/g (refer to Table 1). The coin-type nonaqueous test cell had an initial charge/discharge efficiency of 87.5% and a capacity retention ratio of 76.6% (refer to Table 1). The electrolyte solution degradability was 2.9 mAh/g (refer to Table 1).

### Working Example 15

The target composite particles were obtained proceeding as in Working Example 1, but in this case producing the mixed powder in the “(2) Production of the mixed powder” by introducing the alloy powder and the coal-based pitch powder (softening point=86° C., average particle diameter=20 μm, residual carbon ratio after heating at 1000° C.=50%) into the rocking mixer (Aichi Electric Co., Ltd.) so as to provide a percentage of 90.0% for the mass of the alloy powder with respect to the sum of the mass of the alloy powder and the mass of the coal-based pitch powder. The properties of the composite particles were evaluated as in Working Example 1. The percentage in these composite particles for the mass of the alloy powder with respect to the sum of the mass of the alloy powder and the mass of the coal-based pitch powder-derived material (thought to be mainly carbon precursor) was 95.0% (refer to Table 1).

The maximum grain size (longest diameter) of the silicon phase in the alloy particles obtained as described above was 190 nm, and the BET specific surface area was 0.6 m²/g (refer to Table 1). The coin-type nonaqueous test cell had an initial charge/discharge efficiency of 86.2% and a capacity retention ratio of 86.9% (refer to Table 1). The electrolyte solution degradability was 3.6 mAh/g (refer to Table 1).

### Comparative Example 1

The alloy powder obtained in “(1) Alloy particle production” in Working Example 1 was subjected to an evaluation of the properties of the alloy particles using the methods described in <Evaluation of the properties of the composite particles> in Working Example 1.

The maximum grain size (longest diameter) of the silicon phase in the alloy particles obtained as described above was 100 nm, and the BET specific surface area was 3.7 m²/g (refer to Table 1). The coin-type nonaqueous test cell had an initial charge/discharge efficiency of 88.8% and a capacity retention ratio of 20.3% (refer to Table 1). The electrolyte solution degradability was 10.6 mAh/g (refer to Table 1).

TABLE 1

| | | | Composition and properties of the composite particles | | | | | | |
|---|---|---|---|---|---|---|---|---|---|
| | | | | Percentage | | | | | |
| | | | | of the | | | | | |
| | | | | mass | | | | | |
| | Manufacturing conditions | | | of the Ps | | | | | |
| | Percentage | | | with | Maximum | | Cell properties | | |
| | of the mass | | | respect to | grain size | Specific | Initial | | |
| | of the Ps | | | the Ps + | (longest | surface | charge/ | | Electrolyte |
| | with | Annealing | Main component in | Pt-derived | diameter) of | area | discharge | Capacity | solution |
| | respect to | temperature | the Pt-derived | material | the silicon | value | efficiency | retention | degradability |
| | Ps + Pt (%) | (° C.) | material | (%) | phase (nm) | (m²/g) | (%) | ratio (%) | (mAh/g) |
| Ex. 1 | 96.0 | 400 | carbon precursor | 98.0 | 190 | 2.5 | 87.9 | 60.3 | 2.1 |
| Ex. 2 | 96.0 | 500 | carbon precursor | 98.0 | 261 | 4.5 | 87.8 | 69.7 | 2.0 |
| Ex. 3 | 96.0 | 600 | carbon precursor | 98.0 | 368 | 9.7 | 89.4 | 61.1 | 2.2 |
| Ex. 4 | 96.0 | 700 | nongraphitic carbon | 98.0 | 500 | 10.9 | 89.8 | 72.6 | 2.6 |
| Ex. 5 | 96.0 | 300 | carbon precursor | 96.6 | 143 | 1.2 | 85.3 | 30.2 | 5.5 |
| Ex. 6 | 96.0 | 350 | carbon precursor | 96.6 | 155 | 1.7 | 86.5 | 51.6 | 3.8 |
| Ex. 7 | 98.0 | 400 | carbon precursor | 99.0 | 190 | 3.1 | 87.9 | 49.7 | 1.8 |
| Ex. 8 | 97.0 | 400 | carbon precursor | 98.5 | 190 | 2.8 | 87.9 | 60.0 | 2.1 |
| Ex. 9 | 92.0 | 400 | carbon precursor | 95.8 | 190 | 1.2 | 86.6 | 81.0 | 3.2 |
| Ex. 10 | 96.0 | 800 | nongraphitic carbon | 98.0 | 640 | 13.3 | 89.8 | 75.1 | 2.7 |
| Ex. 11 | 96.0 | 900 | nongraphitic carbon | 98.0 | 860 | 15.7 | 90.3 | 77.7 | 2.8 |
| Ex. 12 | 95.0 | 400 | carbon precursor | 97.5 | 190 | 2.2 | 88.4 | 69.2 | 2.5 |
| Ex. 13 | 94.0 | 400 | carbon precursor | 97.0 | 190 | 1.8 | 88.2 | 73.2 | 2.7 |
| Ex. 14 | 93.0 | 400 | carbon precursor | 96.5 | 190 | 1.5 | 87.5 | 76.6 | 2.9 |
| Ex. 15 | 90.0 | 400 | carbon precursor | 95.0 | 190 | 0.6 | 86.2 | 86.9 | 3.6 |
| Comp. Ex. 1 | 100.0 | — | — | 100.0 | 100 | 3.7 | 88.8 | 20.3 | 10.6 |

“Pt” refers to the thermoplastic organic material powder and “Ps” refers to the alloy powder.

These results demonstrated that the composite particles according to the present invention, when used as the negative electrode active material in a lithium ion secondary cell, exhibit charge/discharge cycle characteristics that are superior to the charge/discharge cycle characteristics of a lithium ion secondary cell in which the negative electrode active material is a silicon phase-containing particle.

### INDUSTRIAL APPLICABILITY

The composite particle according to the present invention is useful as a negative electrode active material for nonaqueous electrolyte secondary cells.

1. A method for manufacturing composite particles, comprising:
a mixing step for producing a mixed powder by mixing particles that contain a silicon phase (referred to herebelow as “silicon phase-containing particles”) with a thermoplastic organic material powder; and
an annealing step for subjecting the mixed powder to an annealing.

2. The method for manufacturing composite particles according to claim 1, wherein the mixed powder is produced in the mixing step by mixing the silicon phase-containing particles and the thermoplastic organic material powder such that the percentage of the mass of the silicon phase-containing particles with respect to the sum of the mass of the silicon phase-containing particles and the mass of the thermoplastic organic material powder is in a range from 85% to 99%.

3. The method for manufacturing composite particles according to claim 1, wherein the mixed powder is annealed in the annealing step at a temperature within a range from 300° C. to 900° C.

4. A composite particle manufactured by the method for manufacturing composite particles according to claim 1.

5. A composite particle comprising:
a particle portion that contains a silicon phase (referred to herebelow as a “silicon phase-containing particle portion); and
a binder portion that binds the silicon phase-containing particle portion and that has at least one of a nongraphitic carbon and a carbon precursor as its main component.

6. The composite particle according to claim 5, wherein the percentage of the mass of the silicon phase-containing particle portion with respect to the sum of the mass of the silicon phase-containing particle portion and the mass of the binder portion is in a range from 92% to 99.5%.

7. The composite particle according to claim 5, wherein at least a portion of the silicon phase-containing particle portion is exposed to the outside.

8. The composite particle according to claim 5, wherein a maximum grain size of the silicon phase is in a range of equal to or less than 1000 nm.

9. The composite particle according to claim 5, having a specific surface area value in a range from 0.5 m²/g to 16 m²/g.

10. An electrode comprising the composite particle according to claim 4 as an active material.

11. A nonaqueous electrolyte secondary cell comprising the electrode according to claim 10.
